(19) United States
(12) Patent Application Publication
(10) Pub. No.: US 2018/0157388 A1
(43) Pub. Date: Jun. 7, 2018

(54) EMOTION EXPRESSION IN VIRTUAL ENVIRONMENT

(71) Applicant: Google Inc., Mountain View, CA (US)

(72) Inventors: Tim Gleason, Jersey City, NJ (US); Christopher Ross, New York, NY (US); Darwin Yamamoto, Brooklyn, NY (US); Ian MacGillivray, New York, NY (US)

(21) Appl. No.: 15/708,977

(22) Filed: Sep. 19, 2017

Related U.S. Application Data
(60) Provisional application No. 62/429,648, filed on Dec. 2, 2016.

(51) Int. Cl. G06F 3/0482; G06F 3/0362; H04L 29/06

(52) U.S. Cl. CPC G06F 3/0482; G06T 11/60; H04L 65/403; G06F 3/0362

(57) ABSTRACT

Meetings held in virtual environments can allow participants to conveniently express emotions to a meeting organizer and/or other participants. The avatar representing a meeting participant can be enhanced to include an expression symbol selected by that participant. The participant can choose among a set of expression symbols offered for the meeting.

### CROSS-REFERENCE TO RELATED APPLICATION

This application claims priority to U.S. Provisional Patent Application No. 62/429,648, filed on Dec. 2, 2016, entitled “EMOTION EXPRESSION IN VIRTUAL ENVIRONMENT”, the disclosures of which are incorporated by reference herein in their entirety.

### TECHNICAL FIELD

This document relates, generally, to emotion expressions in a virtual environment.

### BACKGROUND

In real-world meetings, a speaker or observer may be able to read the room by looking at the facial expressions and body language of other participants. However, this may have limitations and often relies on inference rather than direct feedback. Moreover, in larger sessions, such as when a professor delivers a lecture to hundreds of students, it may be impractical or impossible to interpret so many facial or bodily expressions in a meaningful way. In virtual meetings, on the other hand, participants are sometimes represented by avatars and the ability to do this disappears entirely. Users must then speak to indicate their emotion, which could interrupt the flow of the meeting.

### BRIEF DESCRIPTION OF DRAWINGS

FIG. 1 shows an example of a meeting in a virtual environment.

FIG. 2 shows an example of choosing among expressions using a handheld device.

FIG. 3 shows an example of a system that can be used for virtual meetings.

FIGS. 4-8 show examples of methods.

FIG. 9 shows an example of a computer device and a mobile computer device that can be used to implement the techniques described here.

Like reference symbols in the various drawings indicate like elements.

### DETAILED DESCRIPTION

This document describes examples of meetings held in virtual environments that allow participants to conveniently express emotions to a meeting organizer and/or other participants. In some implementations, the avatar representing a meeting participant can be enhanced to include an expression symbol selected by that participant. For example, the participant can choose among a set of expression symbols offered for the meeting.

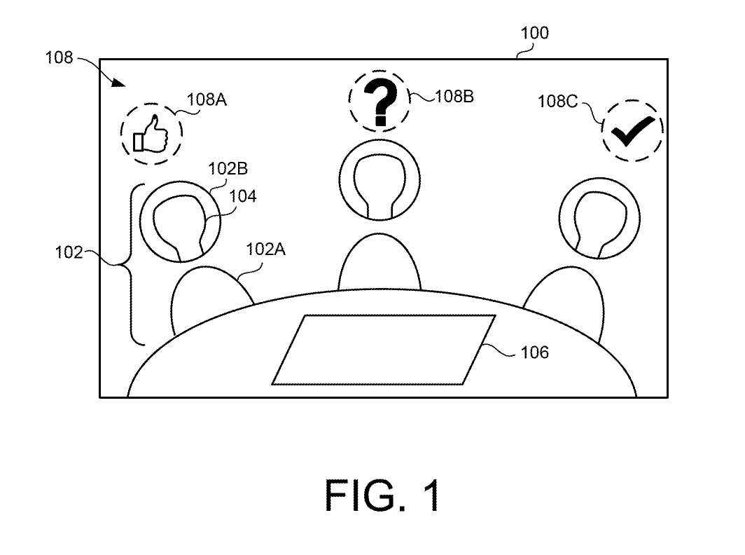

FIG. 1 shows an example of a meeting in a virtual environment 100. For example, this can be a business meeting of employees or business associates according to a predefined agenda. Each meeting participant can be represented by a respective avatar 102. In some implementations, the avatar 102 includes a torso 102A and a head 102B. For example, the head 102B can have applied thereto a representation 104 of that participant, such as a photograph or an image chosen by the participant. Currently, three avatars 102 are visible in the virtual environment 100. For example, the virtual environment 100 as shown in this example can be the view observed from the perspective of a fourth participant (not visible). That is, each participant in the meeting can see a view of the avatars 102 of the other participant(s) when observing the virtual environment 100.

The virtual environment 100 can provide for exchange of audio and/or visual information as part of the meeting. For example, each of the participants can speak into a physical microphone connected to the computer or other device that is facilitating their participation in the meeting, and the audio data can be shared with one or more of the other participants. Exchange of visual information can include that the participants can see one or more avatars 102 of each other. For example, a participant can use a tracking controller that translates gestures or other motions of the body into signals that can trigger a corresponding movement of the respective avatar 102. Exchange of visual information can also or instead include sharing of one or more documents 106 in the virtual environment 100. For example, one of the participants can select a document (e.g., a website) and cause that to be displayed within the virtual environment 100.

One or more expression symbols 108 can be presented in the virtual environment 100. Here, each expression symbol is associated with a corresponding one of the avatars 102. For example, the expression symbol 108 can hover over the head 102B of the respective avatar 102. The expression symbol 108 conveys a certain emotion, sentiment, opinion, state of mind or other personal expression, on behalf of the respective participant. An expression symbol 108A includes a “thumbs-up” symbol. For example, this can signal that this participant agrees with something about the meeting, such as an oral statement or content that is being shared. A corresponding “thumbs-down” symbol (not shown) could convey the opposite message. An expression symbol 108B includes a question mark. For example, this can indicate that this participant wishes to pose a question, or expresses a lack of belief in something that is being shared. An expression symbol 108C includes a checkmark symbol. For example, this can indicate that the participant is ready with some task, or that they have nothing further to add at the moment.

The expression symbols 108 are shown based on an input generated by the respective participant. The expression symbols 108 can be presented silently in the virtual environment 100 so as to not unnecessarily disturb the sharing of audio or visual information. When generated, the expression symbol(s) 108 can be visible to only the meeting organizer, to only the participant who is currently presenting, to only one or more selected participants, or to all participants, to name just a few examples. In some implementations, each participant can have a predefined collection of available expression symbols to choose from, and they can make an input spontaneously or when prompted by another participant or a meeting organizer. For example, this can allow each participant to respond to questions, ask questions, or indicate their general mood or state of agreement.

Any type of symbol, text or other visual expression can be used for the expression symbols 108. For example, the symbols can appear essentially two-dimensional (i.e., as flat objects) or as a three-dimensional virtual object (e.g., the expression symbol 108A can be modeled as a three-dimensional hand. In some implementations, the expression symbol is not separate from the avatar 102. For example, the avatar can be enhanced with a different color, a different brightness, a different size or proportions, a surrounding aura or glow, a different contrast, and/or a different brightness to indicate the expression of a particular emotion.

One or more of the expression symbols 108 can have a dynamic aspect to its appearance. In some implementations, the symbol 108 has a particular appearance when first presented; that is, when the participant makes the input to express a particular emotion. The appearance of the symbol 108 can the gradually be altered over a period of time after the participant's input, to indicate that the expression may not be as relevant or applicable to the present context. For example, the symbol 108 can first be presented with full opacity in the virtual environment 100, and its opacity can then be decreased over a period of time (e.g., a few seconds) until the symbol is essentially no longer visible. Other approaches for indicating lack of contemporaneity can be used, including, but not limited to, decreasing brightness, size, color, contrast and/or sharpness.

The participant may be able to vary the degree of emotion expressed using any or all of the expression symbols 108. In some implementations, the participant can choose between different versions of the symbol 108, such as a prominent version, a default version or a subtle version. For example, the user can make a repeated input of the same emotion to choose the prominent version of the expression symbol 108.

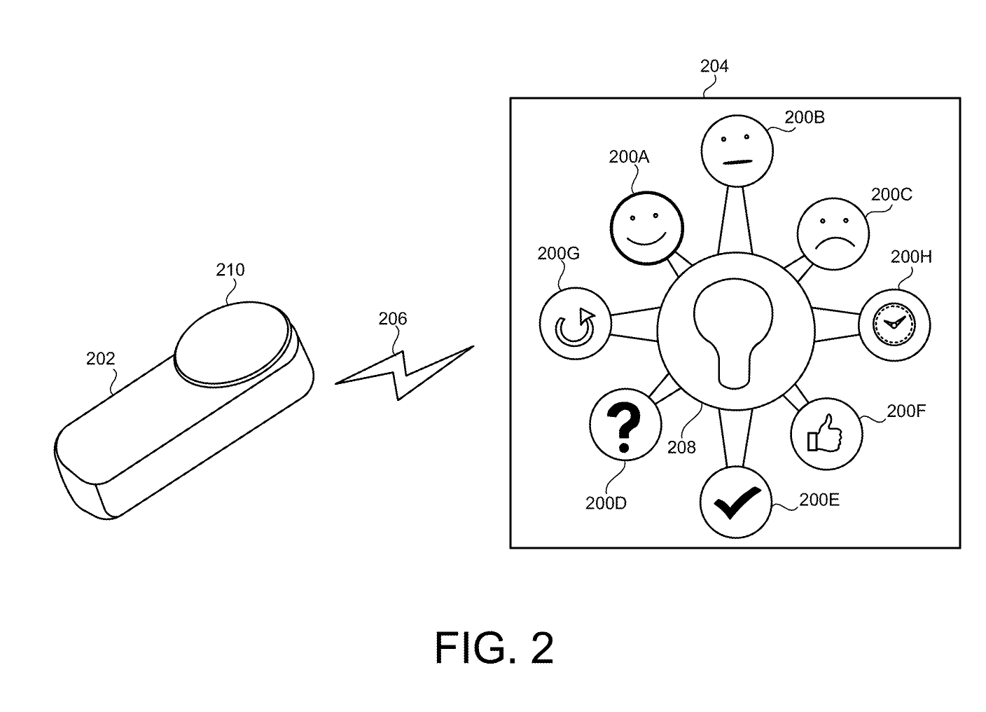

FIG. 2 shows an example of choosing among expressions 200 using a handheld device 202. In some implementations, the expressions 200 are presented on a screen 204, such as the screen where the participant is viewing other content from the virtual environment. For example, the participant can see a large representation of the virtual meeting room (not shown) on the screen 204, with the expressions 200 superimposed on the image of the virtual meeting room. The screen 204 can be the display of a desktop or laptop computer, or the screen of a smartphone or tablet device, or the display of a virtual reality (VR) headset, to name just a few examples.

The device 202 can be any processor-based device capable of communicating with a computer system and thereby interacting with the virtual environment. For example, the device can be or be part of a dedicated controller, a VR headset, a smartphone, tablet or other computing device. The device 202 can serve as a tracking controller to register the movement of the participant's hand or other body part, such that the avatar can be controlled accordingly. As another example, the device 202 can serve as an expression controller for the virtual meeting, allowing the participant to conveniently choose among predefined expressions as a way to react to the audio and/or video of the virtual environment.

The expressions 200 can include multiple expression symbols 200A-H for the participant to choose between. In some implementations, the expressions 200 are distributed on a compass point 208 or other rotary control, such that the participant can choose among them by way of a rotating or spinning motion. For example, the device 202 can have a wheel 210 that can be controlled using the thumb or another finger to make a selection or another input, which is mapped to making a selection among the expressions 200. The currently selected expression can be indicated in a suitable way. For example, the expression symbol 200A is here highlighted as being the selected one. If the participant rotates the wheel 210, another one of the expressions can be highlighted instead.

Any form of emotion, sentiment, opinion, state of mind or other personal expression can be conveyed by the expressions 200. Here, for example, the expressions 200 include the following:
The expression symbol 200A includes a smiley face. For example, this can indicate that the participant agrees with what is being said or shared in the virtual environment.
The expression symbol 200B includes a neutral face. For example, this can indicate that the participant is neither happy nor unhappy about something that is being said or shared.
The expression symbol 200C includes an unhappy face. For example, this can indicate that the participant disagrees with what is being said or shared.
The expression symbol 200D includes a question mark. For example, this can indicate that the participant wishes to pose a question, or expresses a lack of belief in something that is being said or shared.
The expression symbol 200E includes a checkmark. For example, this can indicate that the participant is ready with some task, or that they have nothing further to add at the moment.
The expression symbol 200F includes a “thumbs-up” symbol. For example, this can indicate that the participant agrees with something about the meeting, such as an oral statement or content that is being shared.
The expression symbol 200G includes a “redo” or “repeat” symbol. For example, this can indicate that the participant wishes the current speaker to repeat what was just said.
The expression symbol 200H includes a clock dial. For example, this can indicate that the participant is running out of time, or that the participant is encouraging the current speaker to wrap up the presentation.

In some implementations, the highlighting of any one of the expressions 200 causes that symbol to be presented in the virtual environment (for example, as any of the expression symbols 108 in FIG. 1). In other implementations, an additional input by the participant is needed to trigger the presentation of the expression, such as a clicking on the wheel 210 or another control.

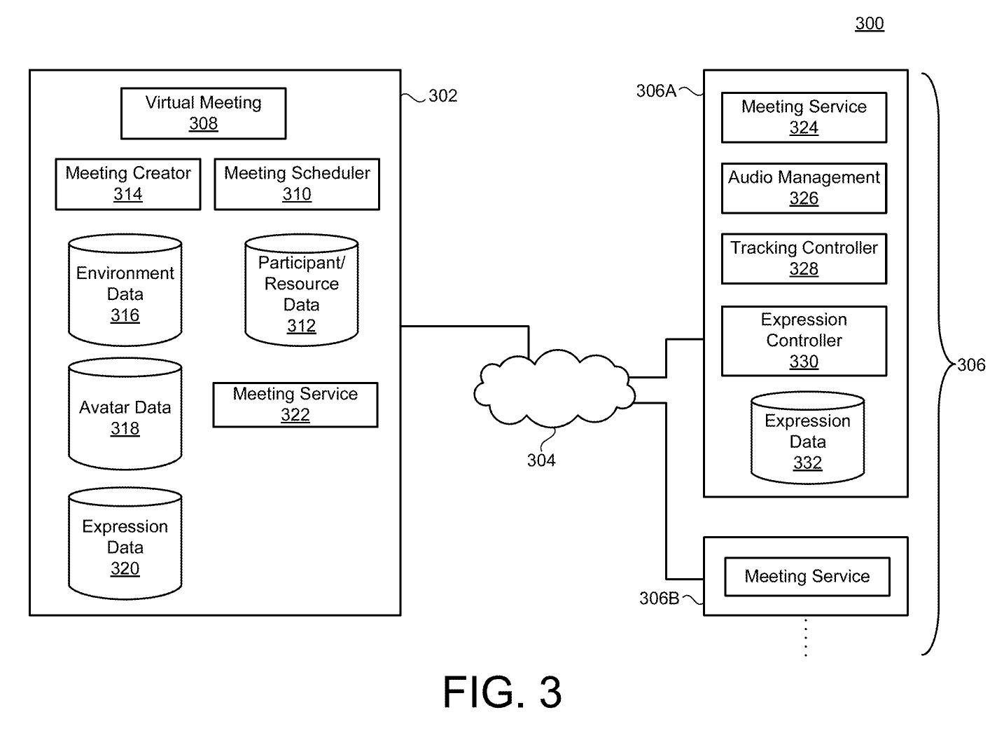

FIG. 3 shows an example of a system 300 that can be used for virtual meetings. The system 300 includes a computer system 302, such as a server, a computer or a portable electronic device. The system 302 can be used for creating meetings in a virtual environment and for controlling audio and visual content that is shared during them. The computer system 302 is connected to one or more networks 304, such as the internet or a private network. Also connected to the network 304 is one or more other computer systems 306, such as a computer, a smartphone or a tablet device. For example, the virtual meeting can be scheduled, created and controlled by the computer system 302 acting as a server in the network, and meeting participants can use one or more of the computer systems 306, acting as a client of that server, to receive the audio and visual information shared and to contribute their own audio or visual information.

The computer system 302 includes a virtual meeting module 308 that can be the overall management tool regarding scheduling, creating and conducting virtual meetings. For example, the module 308 can provide a user interface where a user can control any or all of the above aspects. The computer system 302 can include a meeting scheduler module 310. The module 310 can facilitate scheduling of virtual meetings by way of checking availability of a participant or a resource needed for the meeting, sending meeting requests and tracking the status of them. The module 310 can make use of participant/resource data 312, which can be stored in the computer system 302.

The computer system 302 can include a meeting creator module 314 that can be used for defining the virtual environment and the avatars for the participants, and controlling the availability of expression symbols. The module 314 can use environment data 316. For example, the data 316 can define the appearance of one or more virtual environments and/or what features they should include, such as whether sharing of documents is offered. The module 314 can use avatar data 318. For example, the data 318 can define one or more avatars to represent a participant, including the ability to represent different body postures. The module 314 can use expression data 320. For example, the data 320 can define expression symbols for the participant to choose between, and the corresponding image or visualization of a selected expression symbol can then be generated in the virtual environment.

The meeting creator module 314 can specify a set of expression symbols for the particular meeting being scheduled. In some implementations, the set can be chosen based on a type of meeting being conducted. For example, a meeting between members of a company's management team can be given one set of expression symbols by the meeting organizer, and for a brainstorming meeting where new ideas should be brought up and evaluated, another set of symbols can be used. Such sets of expression symbols can be different from each other or at least partially overlapping.

The computer system 302 can include a meeting service module 322 that can be used for controlling one or more virtual meetings. For example, the module 322 can send to the participants information about the appearance of the virtual environment and the respective avatars of the participants. The module 322 can distribute audio and visual content among all participants corresponding to what is being shared in the virtual environment. In other implementations, a distributed architecture such as a peer-to-peer network can be used, such that each participant can directly forward audio and/or visual information to other participants, without use of a central distributor. When the module 322 is used, it can receive the inputs corresponding to selections of expression symbols by respective participants, and cause the virtual environment to be updated in real time for the relevant participant(s) based on that input. In a distributed environment, the computer system 306 used by the participant who is issuing the expression symbol can provide the information corresponding to the symbol to the other participant(s).

The individual meeting participant can use a computer system such as 306A, 306B, . . . to attend the virtual meeting. For example, the system 306A here includes a meeting service module 324 that can control the visual content to be received by that participant, and the visual content generated by him or her. For example, the module 324 can facilitate that the participant can see an image corresponding to the virtual environment, including the relative appearances and motions of the avatars of other participants, and share the visual output that the participant may generate. The system 306A here includes an audio management module 326 facilitating that the participant can hear audio from other participants, and share the audio output that the participant may generate.

The system 306A here includes a tracking controller 328 that detects motion by the participant such that the avatar can be moved accordingly. For example, the tracking controller 328 can include a VR headset, a data glove, and/or any other device with the ability to detect physical motion, such as a portable device with an accelerometer. The tracking controller 328 can include the handheld device 202 (FIG. 2).

The system 306A here includes an expression controller 330 that the participant uses when an emotion or other expression should be made in a virtual meeting. In some implementations, the expression controller 330 can include software that presents available expression symbols to the participant and defines a way of choosing between them. For example, with reference to FIG. 2 the expression controller 330 can include the expressions 200 controlled by the wheel 210 of the handheld device 202.

The expression controller 330 can use expression data 332. In some implementations, the expression data includes the definitions of various expression symbols that are available to the participant during the meeting. For example, the symbol can be provided by the meeting organizer as a default for the meeting, or they can be a personal set of expression symbols that the participant has compiled, or the can be a combination of the two.

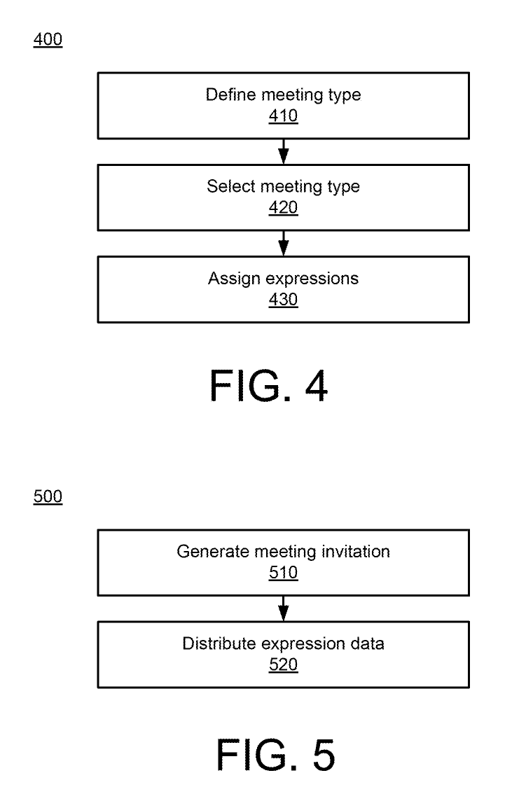

FIGS. 4-8 show examples of methods. The methods can be performed in any implementation described herein, including, but not limited to, in the system 300 (FIG. 3). More or fewer operations than shown can be performed. Two or more operations can be performed in a different order.

FIG. 4 shows a method 400 that relates to assigning a default set of expression symbols to a virtual meeting. At 410, an organizer defines what type of virtual meeting is to be held. For example, this can be a meeting to make executive decisions, to brainstorm new ideas or a teambuilding meeting for a group of subordinates. At 420 the organizer can choose among predefined meeting types based on the definition. At 430, the organizer chooses among available expression symbols for the selected meeting. For example, the organizer can choose to adopt a default set of symbols associated with the selected meeting type, or to use only a subset thereof, or to create a custom set based on the organizer's preferences. The organizer's assignments are stored so that each participant will have the opportunity to use any or all of the expressions during the virtual meeting.

FIG. 5 shows a method 500 that relates to organizing a virtual meeting. At 510, the organizer generates a meeting invitation. For example, this can be sent electronically to multiple intended participants. At 520, expression data for the meeting can be distributed to the participants. In some implementations, this includes expression symbols that should be made available for use by the participant. For example, the expression symbols can be distributed to participants in connection with distributing an agenda for the meeting.

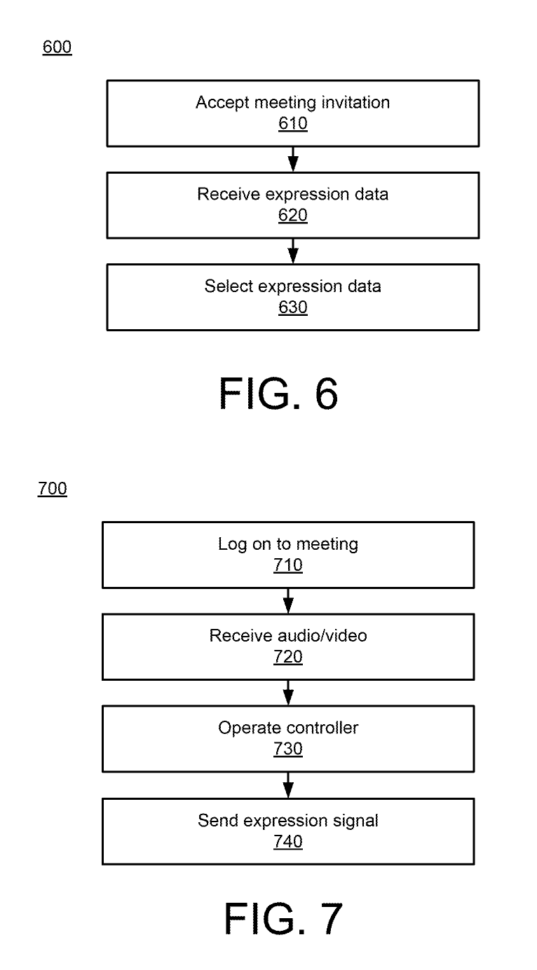

FIG. 6 shows a method 600 that relates to customizing a participant's system with expression symbols. At 610, the participant accepts a received invitation to a virtual meeting. At 620, the participant receives expression data. For example, this can be a set of default expression symbols chosen by the organizer for use in this particular type of meeting. At 630, the participant can select other expression data than that received from the organizer. For example, the participant can choose to also, or instead, include a personal set of expressions for this particular meeting. The total set of expression symbols thus gathered can be stored as expression data 332 (FIG. 3).

FIG. 7 shows a method 700 relating to participating in a virtual meeting. At 710, a participant logs onto a virtual meeting. For example, this can be done using any of the computer systems 306 (FIG. 3). At 710, the participant received audio and/or visual information from the virtual meeting. For example, this can allow the participant to view the virtual environment 100 (FIG. 1). At 730, the participant can operate a controller regarding the virtual meeting. The controller can generate a signal relating to body movement of the participant, or a signal relating to an expression symbol selected by the participant, or combinations thereof. At 740, an expression signal can be sent. In some implementations, the signal relates to an expression symbol chosen by the participant. For example, any of the expressions 200 (FIG. 2) can be chosen.

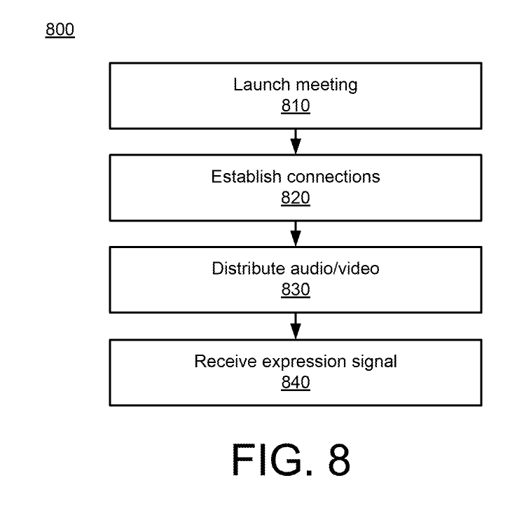

FIG. 8 shows a method 800 relating to conducting a virtual meeting. At 810, a virtual meeting can be launched. For example, this can be done by the computer system 302 (FIG. 3). At 820, connections between participants can be established. For example, this can occur as participants log into the virtual meeting. At 830, audio and visual content of the virtual meeting can be distributed. For example, the virtual environment 100 (FIG. 1) and audio generated by one or more participants can be distributed. At 840, an expression signal can be received. In some implementations, this signal indicates an expression symbol chosen by a participant for presentation in the virtual environment. For example, the participant's avatar in the virtual environment can be updated to also include the expression symbol corresponding to the received signal. The expression signal can remain visible for a remainder of the meeting, or for a shorter time, such as in the example above regarding decreasing opacity.

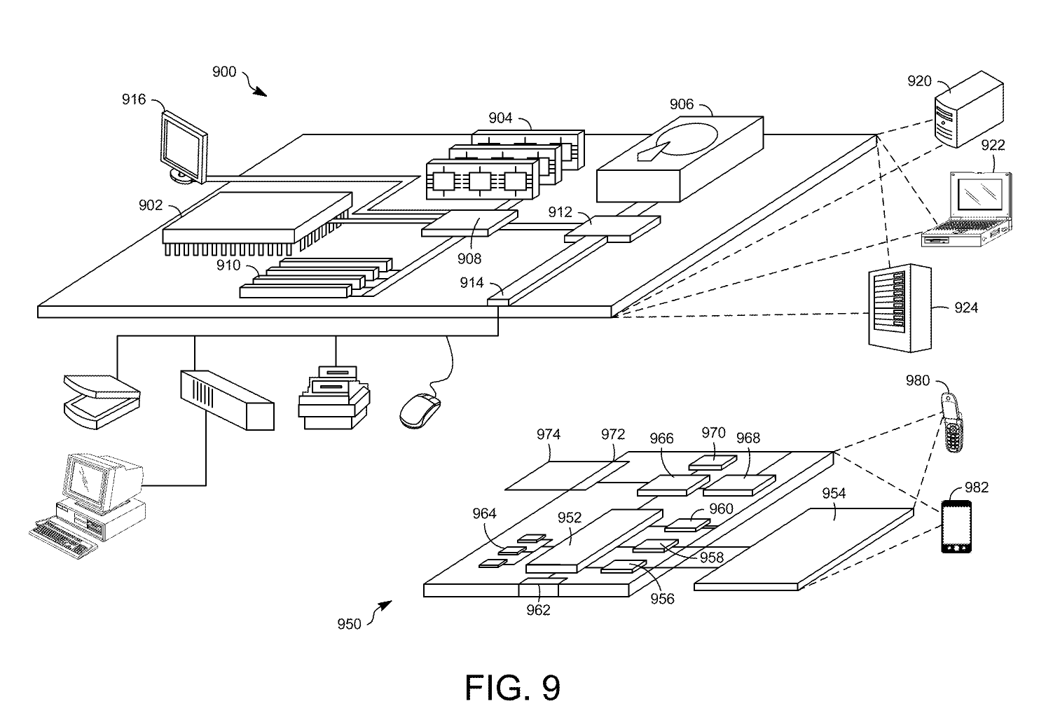

FIG. 9 shows an example of a generic computer device 900 and a generic mobile computer device 950, which may be used with the techniques described here. Computing device 900 is intended to represent various forms of digital computers, such as laptops, desktops, tablets, workstations, personal digital assistants, televisions, servers, blade servers, mainframes, and other appropriate computing devices. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. The processor 902 can be a semiconductor-based processor. The memory 904 can be a semiconductor-based memory. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provided in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provided as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

Further implementations are summarized in the following examples:

### Example 1

A method comprising: defining a type of virtual meeting; selecting one of multiple predefined meeting types based on the defined type; selecting at least one expression symbol from multiple expression symbols associated with the selected predefined meeting type; and storing the selected at least one expression symbol so that each participant in the virtual meeting is able to use the at least one expression symbol during the virtual meeting.

### Example 2

The method of example 1, further comprising sending a meeting invitation to the virtual meeting to invitees of the virtual meeting, and distributing expression data to participants in the virtual meeting, the expression data including the at least one expression symbol.

### Example 3

The method of example 1 or example 2, further comprising associating each participant in the virtual meeting with a respective avatar in a virtual environment of the virtual meeting, and presenting the expression symbol in the virtual environment in association with the avatar.

### Example 4

The method of any of examples 1 to 3, further comprising making the expression symbol visible, in a virtual environment of the virtual meeting, only to an organizer of the virtual meeting.

### Example 5

The method of any of examples 1 to 3, further comprising making the expression symbol visible, in a virtual environment of the virtual meeting, only to a participant of the virtual meeting who is currently presenting in the virtual environment.

### Example 6

The method of any preceding example, further comprising modifying, in a virtual environment of the virtual meeting, a dynamic aspect of an appearance of the expression symbol.

### Example 7

The method of example 6, wherein the modification comprises gradually altering the dynamic aspect over a period of time from when the participant activated the expression symbol.

### Example 8

The method of any preceding example, wherein selecting the expression symbol comprises selecting versions of the expression symbol, each of which expresses a different degree of emotion.

### Example 9

The method of example 8, further comprising selecting one of the versions for presentation, in a virtual environment of the virtual meeting, based on a repeated input made by the participant.

### Example 10

The method of any preceding example, wherein the participant uses a handheld device to interact with the expression symbol during the virtual meeting, the device having a wheel for making input, the method further comprising presenting a rotary control in a virtual environment of the virtual meeting, wherein the participant controls the rotary control using the wheel.

### Example 11

A system comprising: a virtual meeting module that manages a virtual meeting; a meeting scheduler module that schedules the virtual meeting; and a meeting creator module that defines a virtual environment for the virtual meeting and avatars for participants, and controls availability of expression symbols in a virtual environment of the virtual meeting, wherein the meeting creator module chooses the expression symbols from among multiple expression symbols based on a type of the virtual meeting.

### Example 12

The system of example 11, further comprising a meeting service module that controls the virtual meeting, the meeting service module configured to receive participant input during the virtual meeting and to present at least one of the expression symbols based on the input.

### Example 13

The system of example 11 or example 12, further comprising an expression controller that a participant uses to make an expression in the virtual environment during the virtual meeting by selecting one of the expression symbols.

### Example 14

The system of example 13, wherein the expression controller is controlled using a wheel on a handheld device operated by the participant.

### Example 15

A non-transitory storage medium having stored thereon instructions that when executed are configured to cause a processor to perform the method of any of examples 1 to 10.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method comprising:
defining a type of virtual meeting;
selecting one of multiple predefined meeting types based on the defined type;
selecting at least one expression symbol from multiple expression symbols associated with the selected predefined meeting type; and
storing the selected at least one expression symbol so that each participant in the virtual meeting is able to use the at least one expression symbol during the virtual meeting.

2. The method of claim 1, further comprising sending a meeting invitation to the virtual meeting to invitees of the virtual meeting, and distributing expression data to participants in the virtual meeting, the expression data including the at least one expression symbol.

3. The method of claim 1, further comprising associating each participant in the virtual meeting with a respective avatar in a virtual environment of the virtual meeting, and presenting the expression symbol in the virtual environment in association with the avatar.

4. The method of claim 1, further comprising making the expression symbol visible, in a virtual environment of the virtual meeting, only to an organizer of the virtual meeting.

5. The method of claim 1, further comprising making the expression symbol visible, in a virtual environment of the virtual meeting, only to a participant of the virtual meeting who is currently presenting in the virtual environment.

6. The method of claim 1, further comprising modifying, in a virtual environment of the virtual meeting, a dynamic aspect of an appearance of the expression symbol.

7. The method of claim 6, wherein the modification comprises gradually altering the dynamic aspect over a period of time from when the participant activated the expression symbol.

8. The method of claim 1, wherein selecting the expression symbol comprises selecting versions of the expression symbol, each of which expresses a different degree of emotion.

9. The method of claim 8, further comprising selecting one of the versions for presentation, in a virtual environment of the virtual meeting, based on a repeated input made by the participant.

10. The method of claim 1, wherein the participant uses a handheld device to interact with the expression symbol during the virtual meeting, the device having a wheel for making input, the method further comprising presenting a rotary control in a virtual environment of the virtual meeting, wherein the participant controls the rotary control using the wheel.

11. A system comprising:
a virtual meeting module that manages a virtual meeting;
a meeting scheduler module that schedules the virtual meeting; and
a meeting creator module that defines a virtual environment for the virtual meeting and avatars for participants, and controls availability of expression symbols in a virtual environment of the virtual meeting, wherein the meeting creator module chooses the expression symbols from among multiple expression symbols based on a type of the virtual meeting.

12. The system of claim 11, further comprising a meeting service module that controls the virtual meeting, the meeting service module configured to receive participant input during the virtual meeting and to present at least one of the expression symbols based on the input.

13. The system of claim 11, further comprising an expression controller that a participant uses to make an expression in the virtual environment during the virtual meeting by selecting one of the expression symbols.

14. The system of claim 13, wherein the expression controller is controlled using a wheel on a handheld device operated by the participant.

15. A non-transitory storage medium having stored thereon instructions that when executed are configured to cause a processor to perform operations, the operations comprising:
defining a type of virtual meeting;
selecting one of multiple predefined meeting types based on the defined type;
selecting at least one expression symbol from multiple expression symbols associated with the selected predefined meeting type; and
storing the selected at least one expression symbol so that each participant in the virtual meeting is able to use the at least one expression symbol during the virtual meeting.

16. The non-transitory storage medium of claim 15, further comprising associating each participant in the virtual meeting with a respective avatar in a virtual environment of the virtual meeting, and presenting the expression symbol in the virtual environment in association with the avatar.

17. The non-transitory storage medium of claim 15, further comprising modifying, in a virtual environment of the virtual meeting, a dynamic aspect of an appearance of the expression symbol, wherein the modification comprises gradually altering the dynamic aspect over a period of time from when the participant activated the expression symbol.

18. The non-transitory storage medium of claim 15, wherein selecting the expression symbol comprises selecting versions of the expression symbol, each of which expresses a different degree of emotion.

19. The non-transitory storage medium of claim 18, further comprising selecting one of the versions for presentation, in a virtual environment of the virtual meeting, based on a repeated input made by the participant.

20. The non-transitory storage medium of claim 15, wherein the participant uses a handheld device to interact with the expression symbol during the virtual meeting, the device having a wheel for making input, the method further comprising presenting a rotary control in a virtual environment of the virtual meeting, wherein the participant controls the rotary control using the wheel.
